(19) United States
(12) Patent Application Publication
(10) Pub. No.: US 2012/0284773 A1
(43) Pub. Date: Nov. 8, 2012

(54) Network Access Points in Key Distribution Function

(75) Inventors: Thomas Gamer, Oftersheim (DE); Matthias Roth, Kuppenheim (DE); Michael Bahr, Munchen (DE); Christian Schwingenschloegle, Putzbrunn (DE)

(73) Assignee: SIEMENS ENTERPRISE COMMUNICATIONS GMBH & CO. KG, München (DE)

(21) Appl. No.: 13/318,949

(22) PCT Filed: Apr. 15, 2011
(86) PCT No.: PCT/EP2011/001932

§ 371 Date: Nov. 23, 2011

(30) Foreign Application Priority Data
Apr. 26, 2010 (DE) 102010018285.0

(51) Int. Cl. H04W 12/06

(52) U.S. Cl. 726/3

(57) ABSTRACT

Network access node for a terminal integrated wirelessly into the network, including:
a) a memory device having at least one first key and address codes for second access nodes for the terminal,
b) at least one data communications device for exchanging data with the second access nodes,
c) connected with the memory device and the data communications device, a processor with functions for:
d) deriving second keys, among them a second key for securing the connection between the terminal and the second access node, from the first key,
e) secured association of the terminal by using a key derived from the first key,
f) in response to the execution of function d), transmission of the second key for securing the connection between the terminal and the second access node through the data communications device via secured connections and through addressing using the address codes,
   wherein the second keys also include the key used for step e).

### CROSS-REFERENCE TO RELATED APPLICATIONS

This application is the United States national phase under 35 U.S.C. §371 of PCT International Patent Application No. PCT/EP2011/001932, filed on Apr. 15, 2011, and claiming priority to German Application No. DE 10 2010 018 285.0, filed on Apr. 26, 2010.

### BACKGROUND OF THE INVENTION

1. Field of the Invention

Embodiments relate to a network access node for use in a Voice-over-IP application and a Video-on-Demand application, in particular in a local network, especially WLAN.

2. Background of the Related Art

Wireless networks are being used increasingly in homes and offices. A basic standard for such networks is the IEEE 802.11 standard. Mesh networks are wireless networks with a flexible topology. Meshable nodes of a mesh network have features to detect topology changes or to establish fallback routes.

For the Internet, real-time applications such as Voice-over-IP (VoIP) or Video-on-Demand (VoD) are known. Endpoints of real-time communication are usually so-called “stations” or “clients”, i.e., non-meshable terminals.

For integration into a mesh network, these terminals must associate with access nodes of the mesh network. In response to topology changes in the mesh network or the movements of a terminal across multiple wireless cells of the mesh network's access nodes, handover procedures are provided in which the terminal associated with an access node newly associates with another access node of the mesh network.

The speed of the handover procedures for real-time applications is especially critical for the quality and feasibility of such real-time applications using wireless connections. To enable real-time capabilities for non-meshable terminals, the handover procedures from one access node to another should therefore occur with the least possible lag time and packet loss.

802.11 networks operate with fixed access notes, which usually communicate with each other via wired connections.

In mesh networks, the communication for key distribution between the access nodes is less reliable than with wired communication due to the wireless transmission and experiences increased delays due to multi-hop communication. This results in slower handover procedures in mesh networks. Due to the mobility of both mesh nodes and terminals or stations, handover procedures also occur more frequently in mesh networks. The mobility of both mesh nodes and terminals can lead to an increased number of handover procedures. In mesh networks, access nodes operate error-prone communication via a wireless medium, which is typically also carried out across several wireless hops. Thus, a request of a PMK-R1 key through an access node with which a terminal must newly associate requires time and the handover experiences delays.

The IEEE 802.11F standard indicates handover mechanisms in 802.11 networks and is documented in IEEE Trial-Use Recommended Practice for Multi-Vendor Access Point Interoperability via an Inter-Access Point Protocol Across Distribution Systems Supporting IEEE 802.11 Operation, 2003. It does not include any mechanisms for optimizing a handover procedure.

The 802.21 standard concerns the communication and execution of a handover procedure between heterogeneous networks and is documented in Standard for Media Independent Handover Services, IEEE Computer Society/Local and Metropolitan Area Networks, Draft 802.21-Standard, 2004.

Bruce McMurdo, Cisco Fast Secure Roaming, 2004 mentions an acceleration of the authentication after initiating a handover.

To speed up handover procedures, the utilization of several interfaces is demonstrated in Catherine Rosenberg, Edwin K. P. Chong, Hosame Abu-Amara, Jeongjoon Lee, Efficient Roaming over Heterogeneous Wireless Networks, Proceedings of WNCG Wireless Networking Symposium, 2003. To this end, authentication with the new access node is already carried out while the station is still connected to the old node via the second interface.

A standardization for fast handover procedures in wireless 802.11 networks is shown in Draft Amendment to Standard for Information Technology—Telecommunications and Information Exchange between Systems—LAN/MAN Specific Requirements—Part 11: Wireless LAN Medium Access Control (MAC) and Physical Layer (PHY) specifications: Amendment 2: Fast BSS Transition, D2.0, March 2006.

According to the IEEE 802.11r standard, a special key hierarchy is used in wireless 802.11 networks in order to optimize handover procedures. This standardized version of key distribution operates in a manner such that a security relationship with the PMK-R0 key holder must be requested first at the Mobility Domain Controller (MDC), before a PMK-R1 key can be transferred for the handover procedure. This delays the handover procedure.

FIG. 2 schematically illustrates a communication in a handover procedure according to the IEEE 802.11r standard.

After its initial log-on, each access node calculates a PMK-R0 key within a mobility domain. Using a mobility domain controller MDC, it establishes a security relationship with a PMK-R0 key holder. After successful authentication, said key holder is derived from the negotiated master key and is stored on the access node MAP1, where the new access node MAP2 logs on for the first time. This access node MAP1 is also referred to as PMK-R0 key holder. Then, a so-called PMK-R1 key, which forms the basis for protecting the communication with the access node MAP2, is derived from the PMK-R0 key.

The new meshable access node MAP2 receives an authentication request from the terminal STA, which initiates the handover procedure. If the terminal STA initiates a handover procedure in a step S1, then the new access node MAP2 establishes a security relationship with the access node MAP1, which is the PMK-R0 key holder, in a step S0 using the mobility domain controller MDC. There, it requests in a step S2 its “own” PMK-R1 key, which serves as the basis for the protection of the new communication relationship between the terminal STA and the new access node MAP2. To this end, the access node MAP1 derives the PMK-R1 key in a step S3 from the PMK-R0 key and transmits the PMK-R1 key in a step S4 to the new access node MAP2. The new access node MAP2 then transmits an authentication response to the terminal in a step S5, whereupon the terminal associates with the new access node MAP2 in a step S6 such that the handover procedure can be concluded successfully without renewed authentication of the terminal.

### BRIEF SUMMARY OF THE INVENTION

Embodiments of the invention may improve the speed and/or quality of a handover procedure between a first and a second or new access node for a terminal that is integrated wireles sly into the network.

Embodiments of the invention relates to a network access node for a terminal that is wirelessly integrated into the network, a network comprising at least one of these network access nodes, a method for preparing a handover procedure in this netowrk, a method for configuring as embodiment of this network, and a computer program with instructions for the invented methods.

For this purpose, embodiments concern a network access node for a terminal that is integrated wirelessly into the network, comprising:

a) a memory device having at least one first key and address codes of second access nodes for the terminal in the network,

b) at least one data communications device for exchanging data with the second access nodes,

c) connected with the memory device and the data communications device, one or more processor(s) with functions for:

d) derivation of second keys, including a second key for securing the connection between the terminal and the second access node, from the first key,

e) secured associating of the terminal by using a key derived from the first key,

f) in response to the execution of function d), transmission of the second key for securing the connection between the terminal and the second access node through the data communications device with addressing using the address codes via secured connections.

According to embodiments, the second keys also include the key used for step e).

Preferably, the fist key is a PMK-R0 key and the second keys are PMK-R1 keys.

The invention thus enables the distribution of second keys such as PMK-R1 keys to adjacent access nodes of the network access node or also of all access nodes using a mobility domain they have in common with the network access node. Thus, in the case of a handover, no additional delay is generated by requesting the required keys.

Preferably, the network access node is a node of the mesh network.

The second key can encode proprietary features of the terminal, in particular a MAC address.

The first and second keys are in particular symmetrical key pairs, e.g., PMK-R0 and PMK-R1 keys.

The address codes are in particular address codes of all access nodes that have a common mobility domain with the network access node.

The address codes can also be address codes of second access nodes, whose wireless cells form a cluster together with a wireless cell of the network access node for a portion of the network. In this manner, second keys can be distributed in a targeted manner to neighbors of the network access node

Advantageously, only a relatively small bandwidth is required when distributing the PMK-R1 keys to adjacent access nodes of the network access node. The number of second keys to be derived and distributed is therefore relatively small for the network access node.

The PMK-R1 keys could be transmitted using EAPOL key frames, for example. The concrete frame format for the key exchange is not part of the IEEE 802.11r standard.

When distributing the PMK-R1 keys to all access nodes that have a common mobility domain with the network access node, in a mesh network using a reactive or hybrid routing protocol, preferably no significant routing overhead is produced in order to distribute the PMK-R1 keys and little computational effort is required to generate keys for all access nodes of a mobility domain.

During the time that the terminal is active in a mobility domain, the network access node according to the invention may also, if necessary, distribute a portion of the derived second keys still new to the access nodes that are added to the mobility domain and update the address codes in its memory device. Communication adapted to this process, between an authentication server and the network access node, can serve this purpose in the network.

A mesh network according to the invention comprises

at least one network access node according to the invention and multiple second access nodes, preferably more than 3, more preferably more than 4, and more preferably more than 9, possibly forwarding nodes without network access functions for the terminal.

The network according to the invention is established through secured connections among the network access nodes and the second access nodes, possibly via the forwarding nodes, and has secured connections to at least one controller, preferably a mobility domain controller, and to at least one server, preferably an authentication server.

In the mesh network according to the invention with the network access node according to the invention, the cluster is defined in particular such that, between the network access node and each second access node with a wireless cell in the cluster, a connection is established via a maximum of three, or more preferably a maximum of two, or more preferably a maximum of one node.

According to the invention, at least some and preferably all of the second access nodes can be network access nodes.

For transmitting at least some of the second keys, the network preferably features a function for

g) redefining the cluster in response to an embodiment of the association of the terminal with the network access node by updating the address code in the network access node.

A network access node according to the invention as a PMK-R0 key holder can then be provided with functions in order to identify access nodes adjacent to it using a metric to be defined and to transmit the PMK-R1 key of said access node to it, a function that is to be performed after every handover procedure, such that neighbors of a new access node also have the PMK-R1 keys available in case of an additional handover, thus minimizing the delay. One example for such a neighboring metric is then such that all access nodes that are in the network at a distance of no more than one hop from the network access node that is participating in the handover procedure are defined as neighbors. Additional feasible maximum values for the number of hops are, for example, two or three.

In the network according to the invention, the forwarding nodes, i.e., the mesh nodes without access node functionality, also referred to as forwarders, can forward data in order to improve network connectivity, especially in the mesh network. Maximum values for the number of hops can be adapted to the increase in the number of hops caused by the presence of forwarding nodes between access nodes.

Maximum values for the number of hops can be adapted to a situation in which the terminal can communicate with two network access nodes, while these network access nodes do not communicate directly wirelessly with each other, i.e., when a client is situated between two access nodes and can see both of them but the access nodes cannot see each other.

Methods according to the invention are realized by embodying the functions of the network access nodes and/or networks according to the invention described above.

The network according to the invention has connections among access nodes of the network with security relationships. In one embodiment, at least one network access node in the network according to the invention can also be designed as a node with functions of the authenticating server and/or of the mobility domain controller, in order to save hardware resources such as an authenticating server, especially in smaller mesh networks, and instead provide a superior node.

The key distribution strategies made possible by the invention are adapted to the particular characteristics of mesh networks in comparison to 802.11 networks, whereby delays in requesting the PMK-R1 key for a handover procedure are reduced. Thus, it is possible to speed up handover procedures in mesh networks, and real-time applications such as Voice-over-IP can be better supported. Key distribution and key management can be optimized contingent upon a scenario in the network.

### BRIEF DESCRIPTION OF THE FIGURES

Aspects and exemplary embodiments of the invention are described below with reference to the figures, in which:

FIG. 1 schematically illustrates a network access node;

FIG. 2 schematically illustrates a communication in a handover procedure according to the IEEE 802.11r standard;

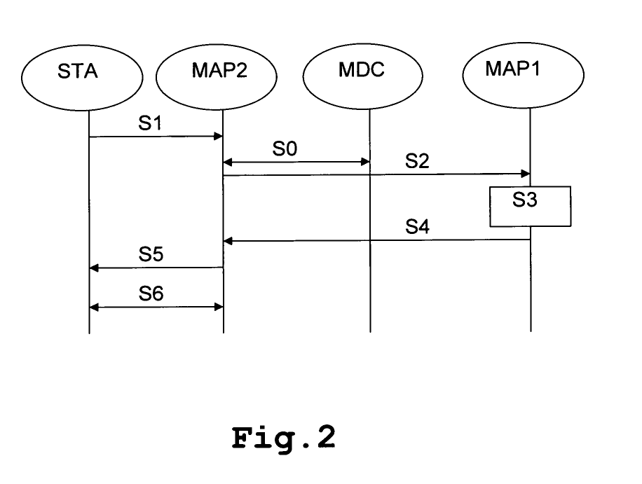

FIG. 3 schematically illustrates a communication according to the invention;

FIG. 4 illustrates a network of the invention connected with a terminal.

### LIST OF REFERENCE NUMBERS

1 Memory device

2 Data communications device

3 Processor

4 BUS

AS Authentication server

STA Terminal

MAP1 initial network access node

MAP2, . . . MAPn second access nodes

MP1, MP2, MP3 forwarding nodes

MDC Mobility domain controller

### DETAILED DESCRIPTION OF THE INVENTION

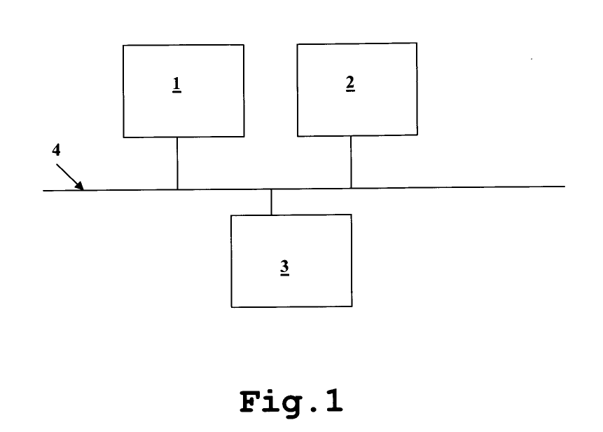

In the network access node of the invention shown in FIG. 1, a processor 3 is connected to a memory device 1 and a data communication device 2 via a BUS 4. The memory device stores a PMK-RO key and address codes of second access nodes MAP2, . . . , MAPn of a network with the network access node.

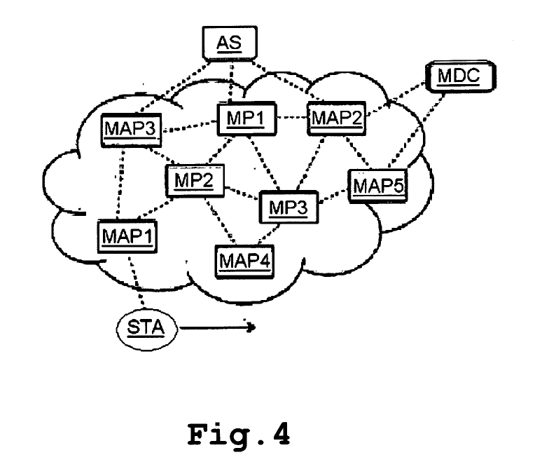

FIG. 4 shows a mesh network of the invention in connection with a terminal STA. The network features five meshable access nodes MAP1, MAP2, MAP3, MAP4, MAP5 and three forwarding nodes MP1, MP2, MP3, an authentication server AS and a mobility domain controller MDC. Connected to the network is a non-meshable mobile station as the terminal STA.

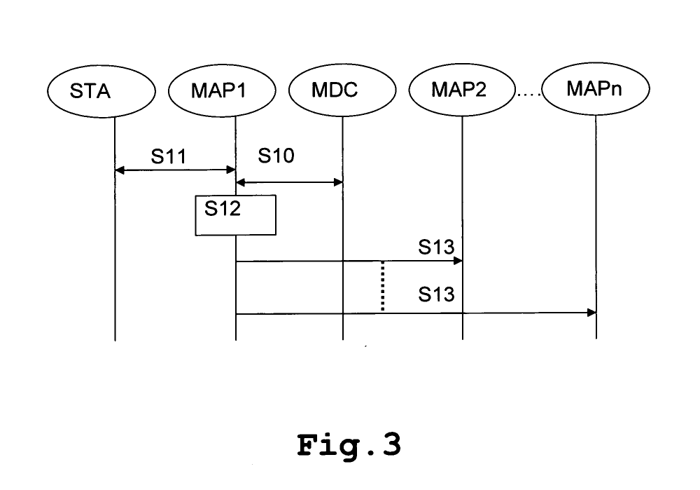

FIG. 3 illustrates the communication in the network shown in FIG. 4.

All meshable access nodes MAP1, MAP2, MAP3, MAP4, MAP5 have already been authenticated in the authentication server AS and are therefore active components of the mesh network shown. Initially, the station authenticates itself via the access node MAP1, and this authentication information is forwarded to the authentication server AS. The authentication server AS performs the verification of the access authorization and upon successful authentication generates a master key. It then transmits this master key to the initial access node MAP1, which derives from it the PMK-R0 key. In its function as the PMK-R0 key holder, the initial network access node MAP1 stores the PMK-R0 key locally in its memory device 1. Directly following the authentication of the STA, the network access node MAP1 derives four additional PMK-R1 keys for the access nodes MAP3, MAP2, MAP4 and MAP5. The PMK-R1 key forms the basis for the protection of the communication relationship between the initial network access node MAP1 and the station STA that is now associated with the mesh network. Following the establishment of a security relationship with all of these access nodes using the mobility domain controller MDC, the PMK-R1 keys are transferred from MAP1 to the respective access nodes MAP3, MAP2, MAP4 and MAP5. If, at a later point, the station initiates a handover procedure, for example to the new access node MAP4, then said access node already has the appropriate PMK-R1 key. The new access node MAP4 can thus perform the handover procedure without additional communication with the mobility domain controller MDC and the network access node as the PMK-R0 key holder MAP 1.

The network illustrated in FIG. 4 uses a corresponding method illustrated in FIG. 3 comprising the following steps:

S10 Security relationships are established between the initial network access node MAP1 and all additional access nodes MAP2, MAP3, MAP4, MAP5, whose address codes are received by the mobility domain controller MDC and stored in a memory device 1 of the initial network node MAP1, and the access nodes MAP1, MAP2, MAP3, MAP4, MAP5 are authenticated at the authentication server AS,

S11 Authentication of the terminal STA is initiated at the initial network access node MAP1 by performing the following steps:
Transmitting authentication information from the terminal via the initial network access node MAP1 to the authentication server AS,
Verifying the authentication information through the authentication server AS followed by generation of the master key,
Transmitting the master key to the initial network access node MAP1,
Deriving the PMK-R0 key from the master key through the initial network node (MAP1) and storing the first key in the memory device 1 of the initial network access node,
   The following steps occur after deriving a PMK-R1 key from the PMK-R0 key for the terminal STA, with the resulting secured association of the terminal:

S12 Deriving additional PMK-R1 keys through the initial network access node MAP1 and

S13 Transmitting the additional PMK-R1 keys to at least the access points MAP2, MAP3, MAP4, MAP5.

Alternatively, the initial network access node does not transmit the PMK-R1 keys of the station STA to all other active access nodes of the mobility domain after the initial authentication, but rather only to adjacent access nodes that are at a maximum distance of, for example, n hops from it, where n is 1 to 3, preferably 2. After the initial authentication of the station STA, the initial access node MAP1 then calculates the PMK-R1 keys, for example for the adjacent access nodes MAP3 and MAP4, and transmits said keys to them. With this distribution strategy, a later handover procedure of the station to the new access node MAP4 can also be performed without additional communication with the MDC and the PMK-R0 key holder. However, following a successful handover procedure, the access node MAP1 as the PMK-R0 key holder must be notified in order for it to be able to derive additional PMK-R0 keys and distribute them to additional access nodes that are adjacent to the new access node MAP4. In the above example, these are the access nodes MAP2 and MAP5.

1. A network access node for a terminal integrated wirelessly into a network, comprising:
a) a memory device having at least one first key and address codes of second access nodes for a terminal in a network,
b) at least one data communications device for exchanging data with the second access nodes,
c) connected with the memory device and the data communications device, at least one processor with functions for:
deriving second keys, among them a second key for securing the connection between the terminal and the second access node, from the first key,
secured association of the terminal by using a key derived from the first key, and
in response to the execution of the derivation of second keys, transmission of the second key for securing the connection between the terminal and the second access node by the data communications device via secured connections and with addressing using the address codes,
wherein the second keys also include the key derived from the first key.

2. The network access node of claim 1, wherein the network access node is a node in a mesh network.

3. The network access node of claim 1, wherein the second key encodes proprietary features of the terminal.

4. The network access node of claim 1, wherein the first and second keys are symmetric key pairs.

5. The network access node of claim 2, wherein the address codes are address codes for all access nodes in the network that have a common mobility domain with the network access node.

6. The network access node of claim 2, wherein the address codes are address codes for access nodes under the second access nodes, whose wireless cells form a cluster together with a wireless cell of the network access node for a portion of the network.

7. A network, comprising:
at least one network access node of claim 6, and
multiple second access nodes, preferably more than 3,
optionally forwarding nodes,
wherein the network is established through secured connections among the at least one network access node and the second access nodes, optionally via the forwarding nodes, and wherein the network has secured connections to at least one controller, and at least to one server.

8. The network of claim 7, wherein the cluster is defined such that a connection is established between the network access node and each second access node with a wireless cell in the cluster via a maximum of three, access nodes.

9. The network of claim 7, wherein at least a some of the second access nodes are network access nodes.

10. The network of claim 9, comprising a function redefining the cluster in response to secured association of the terminal using a key derived from the first key in a network access node by updating the address codes in the network access node.

11. A method for preparing a handover procedure in a network of claim 7,
wherein all second access nodes whose address codes are stored in the memory device of the initial network node are authenticated by the authentication server and an authentication of the terminal is initiated at the initial network node, comprising:
transmitting authentication information from the terminal via an initial network node to the authentication server,
verifying the authentication information by the authentication server, followed by generating a root key,
transmitting the root key to the initial network node,
deriving the first key from the root key through the initial network node and storing the first key in the memory device of the initial network node,
performing the following steps with the initial network node:
deriving a second key from the first key, and
securing association of the terminal by using the second key, and in response to the step of deriving the second key from the first key performing the distinguishing steps of
deriving additional second keys through the first network node, and
transmitting the additional second keys to at least some of the second access nodes of the network.

12. The method of claim 11, wherein the initial network node has an address code for all access nodes in the network that have a common mobility domain with the network access nodes and wherein the additional second keys are each transmitted to all access nodes of the network that have a common mobility domain with the initial network node as defined by the mobility domain controller.

13. The method of claim 11, wherein additional second keys are each transmitted to all second access nodes whose wireless cells make up the cluster.

14. The method of claim 10 for configuring a network, comprising executing the steps of claim 13 wherein the cluster is redefined in response to secured association of the terminal using a key derived from the first key in a network access node by updating the address codes in the network access node.

15. A computer-readable storage medium comprising instructions that when executed perform the method of claim 11.
